(19) United States
(12) Patent Application Publication
(10) Pub. No.: US 2025/0369284 A1
(43) Pub. Date: Dec. 4, 2025

(54) ADAPTABLE SAFETY HANDRAIL SYSTEM FOR PORTABLE LADDERS

(71) Applicant: Vijay M. Sethna, Fremont, CA (US)

(72) Inventor: Vijay M. Sethna, Fremont, CA (US)

(21) Appl. No.: 19/218,499

(22) Filed: May 26, 2025

Related U.S. Application Data
(60) Provisional application No. 63/652,204, filed on May 28, 2024.

(51) Int. Cl. E06C 7/18

(52) U.S. Cl. CPC E06C 7/183

(57) ABSTRACT

An adaptable safety handrail system configured for temporary attachment to a ladder is disclosed. The system includes a pair of mounting assemblies, each comprising a press mechanism for tool-free engagement with respective ladder stiles and a friction-enhancing interface to inhibit slippage. A sleeve within each mounting assembly receives an upright support member and is provided with multiple holes to permit vertical adjustment by engaging a locking element. A rotatable circular plate fixed to the sleeve allows angular adjustment of the upright support member, with a locking mechanism to secure the angle. A handrail member extends between the upright support members and includes a telescopic mechanism enabling horizontal length adjustment to accommodate differences in vertical extension, with a locking element to fix the selected length. The system offers multi-axis configurability, ease of installation, and enhanced ladder safety, providing a continuous, stable handhold to mitigate fall risk during ladder use.

### CROSS REFERENCE TO RELATED APPLICATIONS

This application claims benefit of U.S. Provisional Application Ser. No. 63/652,204 entitled “Collapsible Safety Handrails for Ladders”, filed May 28, 2024, which is incorporated herein in its entirety.

### TECHNICAL FIELD

The disclosure relates generally to ladder-mounted accessories and—more particularly—to auxiliary hand-support structures intended to improve user safety during ladder ascent and descent.

### BACKGROUND OF THE INVENTION

Portable ladders are indispensable in residential, commercial, and industrial environments because they provide rapid, low-cost access to elevated work locations. Despite their ubiquity, ladders remain a leading source of occupational and domestic injuries. Accident statistics published by diverse safety bodies (e.g., OSHA in the United States, the U.K. Health & Safety Executive, and comparable agencies worldwide) consistently rank falls from ladders among the most common causes of non-fatal but debilitating workplace incidents. Injuries range from minor contusions to life-altering fractures and head trauma, and they impose significant medical costs, lost productivity, and, in severe cases, permanent disability.

A fundamental reason ordinary ladders are hazardous is their lack of an integrated upper-body support. When a user climbs, the hands are occupied by alternately grasping ladder rungs; at the same time, the center of mass moves away from the supporting structure, especially when tools or materials are carried. Loss of balance or foot misplacement often results in an uncontrolled fall. Numerous safety codes stipulate that fixed stairs above certain heights must have guardrails or handrails on one or both sides, yet portable ladders remain largely exempt from those regulations, even though they are frequently used under similar height conditions. The absence of a stable, waist-height or chest-height handhold leaves the climber with limited options to arrest imbalance.

Various aftermarket attachments have been proposed to mitigate ladder risks. Simple rope or webbing “grab lines,” for example, can be anchored near the ladder top to provide a supplemental handhold. However, flexible lines lack rigidity and do not supply the same proprioceptive feedback or leverage that a rigid rail provides, and therefore cannot reliably prevent lateral tipping or sudden backward movement. Other products employ rigid posts or stanchions that bolt directly to ladder stiles. These tend to be designed for a specific ladder model or stile cross-section; as such, they sacrifice universality in favor of secure fastening. If a contractor operates multiple ladder types (A-frame, extension, telescoping, or specialty configuration), stockpiling different accessories for each model is impractical and cost-prohibitive.

Another class of devices relies on brackets that straddle the ladder top and clamp onto a roof edge or parapet. While these brackets can furnish a high anchor point, they are primarily intended to stabilize the ladder against lateral displacement rather than to provide the user with continuous hand support throughout a climb. Moreover, roof-edge anchoring is useless for tasks performed on mid-span rungs or on job sites devoid of a suitable edge fixture. Some manufacturers integrate fixed grab bars directly into specialty ladders; those offerings are appreciably more expensive than commodity ladders and lack adjustability once fabricated.

The ergonomic variability of end users adds another difficulty. Workers differ in stature, reach, dominant hand, and vertical work posture. A handrail affixed at a single, non-modifiable height may function for a tall individual but be ineffective for someone shorter, or vice-versa. Furthermore, ladder angles vary by application. Extension ladders placed against a wall follow the 4-to-1 rule and lean at roughly 75.5°, whereas telescoping “little giant”-type ladders can be configured in steeper, shallower, or scaffold positions. A static hand-support accessory cannot accommodate all these angular variations without compromising either clearance or leverage.

Traditional metal-working and construction operations routinely require personnel to carry paint cans, power tools, or fasteners while climbing. The presence of bulky objects in a climber's hand decreases grip security on ladder rungs, heightening the value of an auxiliary support. Yet, occupational standards emphasize minimizing setup time; crews are often unwilling to spend extra minutes bolting or unbolting complex attachments. Consequently, a commercially viable safety rail must install and remove rapidly, preferably without wrenches, Allen keys, or impact drivers. Tool-free installation is especially valued by trades that perform many short, repetitive ladder moves-such as electricians, sheet-metal installers, HVAC technicians, and sign fitters.

Durability considerations impose further constraints. The accessory should withstand repeated fastening cycles, vibration during transport, and outdoor exposure to moisture, UV radiation, and temperature swings. But weight must be kept low to avoid exceeding the ladder's load rating or burdening the operator with heavy add-ons. Thanks to recent advances in lightweight structural tubing, knurled knobs, and elastomeric contact pads, it has become technically feasible to design a rigid, adjustable handrail that can be clamped to heterogeneous ladder stiles without marring their surfaces. Even so, delivering simultaneous adjustment in three degrees of freedom vertical, horizontal, and angular-poses significant mechanical-integration challenges. Any pivot allowing rotation must be positively lockable to prevent creep under dynamic loads, yet simple enough for one-handed actuation. Likewise, telescopic features must offer fine granularity of extension while maintaining structural rigidity when locked.

A persistent gap therefore exists between: (i) simple ladder stabilizers that do not furnish a true upper-body support; and (ii) sophisticated but tool-dependent, model-specific accessories that are incompatible with diverse ladder geometries and rapid repositioning workflows. The safety community has called for an attachment that combines universal adaptability, multi-axis configurability, tool-free operation, compact stowage, and robust load-carrying capability—without materially altering the ladder's weight balance or interfering with ladder rung access. Despite incremental improvements in clamping hardware and telescopic poles, no readily available product holistically addresses these concurrent requirements. As a result, workers still resort to ad-hoc tethering, improvised grab points, or forego supplementary support altogether, perpetuating preventable ladder-related injuries and associated economic losses. Industry stakeholders therefore continue to seek a practical solution that can retrofit existing ladder inventories while satisfying emerging safety regulations and ergonomic best practices.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

The present disclosure provides an adaptable safety handrail system designed for temporary attachment to a ladder to enhance user safety during climbing and/or descending activities. The system features a pair of mounting assemblies configured to be secured to opposing ladder stiles using a press mechanism that incorporates a friction-enhancing interface to ensure secure engagement without marring the ladder surface. Each mounting assembly includes a sleeve that receives an upright support member and incorporates a series of holes; a locking element selectively engages one of these holes to secure the upright support at a user-selected vertical height. A rotatable circular plate, fixed to the sleeve and defining a rotation axis parallel to the ladder stile, provides a tilt adjustment mechanism. The angle of the upright support is set by rotating this plate and secured using an integrated locking feature, allowing the system to adjust to a range of angular orientations relative to the ladder stiles.

Spanning between the upright support members is a handrail member equipped with a telescopic mechanism that allows the handrail's horizontal length to be adjusted to compensate for differences in the vertical positions of the upright supports. The handrail telescopic mechanism includes a locking element that secures the handrail at the chosen length, ensuring stability and continuity of support. This modular design enables user-selectable adjustment in vertical, horizontal, and angular dimensions, all without the use of tools. The safety handrail system is designed for quick and easy installation and removal, offering a practical, ergonomic solution for improving ladder safety in residential, commercial, and industrial applications.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 is a perspective view 100 of the complete safety handrail system mounted on a ladder according to the embodiments of the present disclosure.

FIG. 2 is an exemplary perspective view 200 of the safety handrail system disclosing all the core components according to the embodiments of the present disclosure.

FIG. 3 is an exemplary close-up view 300 of the mounting assembly and pivot mechanism connected to one of the ladder stiles according to the embodiments of the present disclosure.

FIGS. 4-7 are different exemplary perspective views 400, 500, 600, and 700 of the safety handrail system disclosing all the core components according to the embodiments of the present disclosure.

FIG. 8 is another exemplary close-up view 800 of the mounting assembly disclosed in FIG. 3 according to the embodiments of the present disclosure.

FIG. 9 is the rear-side close-up view 900 of the mounting assembly disclosed in FIGS. 3 and 8 according to the embodiments of the present disclosure.

FIG. 10 is an exemplary rear perspective view 1000 of the safety handrail system according to the embodiments of the present disclosure.

### DETAILED DESCRIPTION

Portable ladders, whether used in domestic, commercial, or industrial settings, continue to pose significant safety risks. Traditional ladder designs rely solely on the user's ability to maintain balance while ascending or descending, using the rungs and side rails as the only available handholds. The inherent instability of ladders-compounded by their lightweight construction, uneven supporting surfaces, and the need for users to carry tools or materials-substantially increases the risk of slips, missteps, and falls. These dangers are further aggravated by the lack of dedicated handrail structures that provide stable upper-body support, especially during transitions between ladder use and elevated platforms. Although regulatory bodies mandate fixed handrails for permanent structures like stairs and ramps, ladders remain largely exempt, leaving a persistent gap in user safety measures.

Existing aftermarket ladder attachments, including stabilizers and grab rails, offer limited functionality and adaptability. Many such solutions are either ladder-model-specific, requiring tools and complex assembly procedures, or offer only a single-axis adjustment, restricting usability in diverse working conditions. The inability to accommodate variations in ladder geometry, user height, and work positioning undermines the effectiveness of these attachments. Furthermore, portable handrail solutions often fail to combine stability, ease of installation and removal, and compactness for storage and transport. There is, therefore, a pressing need for a versatile, tool-free handrail system capable of integrating with existing ladders, offering secure and adjustable support in multiple axes, and providing the ergonomic advantages of a fixed handrail with the adaptability required for portable ladder applications.

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments maybe utilized and that changes may be made without departing from the scope of the present invention. The following detailed description is, therefore, not to be taken in a limited sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. A single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the foregoing sections, some features are grouped together in a single embodiment for streamlining the disclosure. This method of disclosure is not to be interpreted as reflecting an intention that the disclosed embodiments of the present disclosure must use more features than are expressly recited in each claim. Rather, as the following claims reflect, the inventive subject matter lies in less than all features of a single disclosed embodiment. Thus, the following claims are hereby incorporated into the detailed description, with each claim standing on its own as a separate embodiment.

The present disclosure provides an adaptable safety handrail system configured for temporary attachment to a ladder. The system includes a pair of mounting assemblies configured to be removably secured to respective ladder stiles. Each mounting assembly comprises a press mechanism configured to secure the mounting assembly to the ladder stile with a friction-enhancing interface, thereby ensuring stable engagement without the need for tools or ladder modifications. The press mechanism incorporates a knob or actuator that applies a clamping force to the ladder stile, utilizing opposed jaws that can be drawn together to grip the stile surface. The interior surfaces of the jaws are optionally provided with removable pads formed of a resilient, friction-enhancing material to protect the ladder surface from damage and increase grip. The mounting assembly further includes a width-adjustment guide that accommodates ladder stiles of varying thicknesses, ensuring universal compatibility with different ladder models.

Integral to each mounting assembly is a height adjustment mechanism comprising a sleeve, through which an upright support member is slidably received. The sleeve includes a plurality of apertures arranged along its sidewalls. The upright support member extends through the sleeve and is provided with corresponding holes along its length. A locking element in the form of a spring-loaded pop-pin or manual locking pin is configured to engage one of the apertures in the sleeve and a corresponding hole in the upright support member. This engagement secures the upright support member at a desired vertical position relative to the ladder stile. The configuration of the sleeve and locking element allows for coarse adjustment of the vertical height of the upright support member by selecting different engagement holes, providing flexibility for users of different statures and work heights.

In addition to the vertical adjustment, each mounting assembly is further provided with an angle adjustment mechanism. The angle adjustment mechanism comprises a rotatable circular plate fixed to the sleeve, the circular plate defining an axis of rotation substantially parallel to the ladder stile. This arrangement allows the upright support member to pivot around this axis, thereby adjusting its tilt angle relative to the ladder stile. A locking feature associated with the circular plate, such as a friction-disc clamp tightened by a manual knob, secures the selected angular orientation of the upright support member. This locking mechanism ensures that the upright support member remains stable and fixed during use, even when subjected to lateral forces or vibrations, and can be readily disengaged by the user for reconfiguration.

The upright support members, once secured in the sleeves of the mounting assemblies, extend upward from the ladder and serve as attachment points for a handrail member. The handrail member is designed to span the space between the two upright support members, thereby providing a continuous and stable handhold for users ascending or descending the ladder. The handrail member includes a telescopic mechanism that permits horizontal length adjustment to accommodate variations in the vertical positions of the upright support members. This telescopic feature allows the handrail to remain continuously connected to both upright support members, even when they are adjusted to different heights, thereby ensuring uninterrupted support. A locking mechanism associated with the telescopic mechanism, such as a manual knob, lever, or pin, secures the handrail at the selected horizontal length to maintain its stability during use.

The combined effect of the adjustable press mechanism, the vertical height adjustment mechanism, the angle adjustment mechanism, and the telescopic handrail member ensures that the safety handrail system offers user-selectable adjustment along vertical, horizontal, and angular axes. The press mechanism enables rapid, tool-free installation and removal of the mounting assemblies from the ladder stiles. The vertical height adjustment allows users to position the handrail at an ergonomically suitable height, while the angle adjustment mechanism permits precise angular alignment of the handrail relative to the ladder's orientation. The telescopic handrail mechanism ensures that the handrail can bridge the distance between upright supports, irrespective of their vertical offsets, while maintaining a rigid and supportive structure.

In operation, the system is attached by securing each mounting assembly to a ladder stile. The press mechanism applies sufficient clamping force to ensure that the mounting assembly remains fixed in place during use. The upright support members are then adjusted to the desired height by sliding them through the sleeves of the mounting assemblies and engaging the locking pins or pop-pins into the selected apertures. The angle of each upright support member is set by rotating the circular plate relative to the sleeve and tightening the friction-disc clamp or equivalent locking feature to lock the desired tilt. The handrail member is then extended horizontally until it reaches both upright support members, at which point the telescopic mechanism is locked to fix its length. This configuration ensures that the user is provided with a stable, ergonomically positioned handrail for the duration of the ladder operation.

For disassembly, the user disengages the locking mechanisms of the telescopic handrail, the angle adjustment circular plate, and the height adjustment pop-pins. The press mechanisms are then released to remove the mounting assemblies from the ladder stiles. The components may be folded or collapsed into a compact configuration for storage or transport. The tool-free nature of the system ensures rapid deployment and stowage, making it suitable for use in environments where ladders are frequently repositioned or stored.

The system may be fabricated from durable materials such as aluminum or steel for structural components, with elastomeric or polymeric materials used for pads and friction interfaces. These materials provide the necessary combination of strength, weight reduction, and resistance to environmental factors such as moisture and UV exposure. The locking features, including the pop-pins, knobs, and friction-disc clamps, are designed for ease of manual operation without tools, ensuring that users can adjust the system as needed with or without using hand gloves or with limited dexterity.

The telescopic mechanisms of both the upright supports and the handrail member are configured to provide smooth extension and retraction with minimal play or backlash. The sliding components are dimensioned and toleranced to ensure a secure fit, reducing the likelihood of unintended movement during use. The locking features of the telescopic mechanisms engage positive stops or detents to prevent slippage and ensure that the selected length remains fixed under load.

The system accommodates a range of ladder styles and sizes, with the width-adjustment guides and resilient friction pads of the press mechanisms adapting to ladder stiles of varying profiles and cross-sections. This universal compatibility eliminates the need for ladder-specific accessories and allows the system to be deployed across different job sites and tasks. The angle adjustment mechanism provides sufficient rotational range to accommodate ladders set at varying angles, such as extension ladders, step ladders, or combination ladders, ensuring consistent handrail positioning regardless of ladder configuration.

The design of the system balances ease of use, adjustability, and structural integrity. The combination of telescopic extension, angular rotation, and positive locking mechanisms provides a robust and reliable handrail system that enhances user safety. The ability to install and remove the system without tools streamlines worksite operations, reduces setup time, and ensures that the system can be readily deployed wherever ladder use is required. By providing a secure, adjustable, and universally compatible safety handrail, the system addresses the longstanding need for improved ladder safety in diverse working environments.

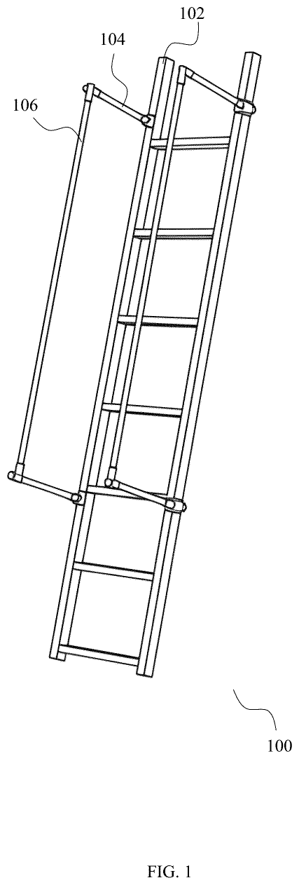

FIG. 1 illustrates a perspective view of the complete safety handrail system 100 mounted on a ladder structure. The system 100 includes a pair of mounting assemblies 210 that are removably secured to the opposing ladder stiles 102. Extending from each mounting assembly 210 is an upright support member 104, which serves as the structural link between the mounting assembly and the handrail member 106. The handrail member 106 spans horizontally between the two upright support members 104, creating a continuous hand-support structure. The mounting assemblies 210 are shown clamped securely onto the ladder stiles 102, and the entire system 100 is configured to provide enhanced safety during ladder use.

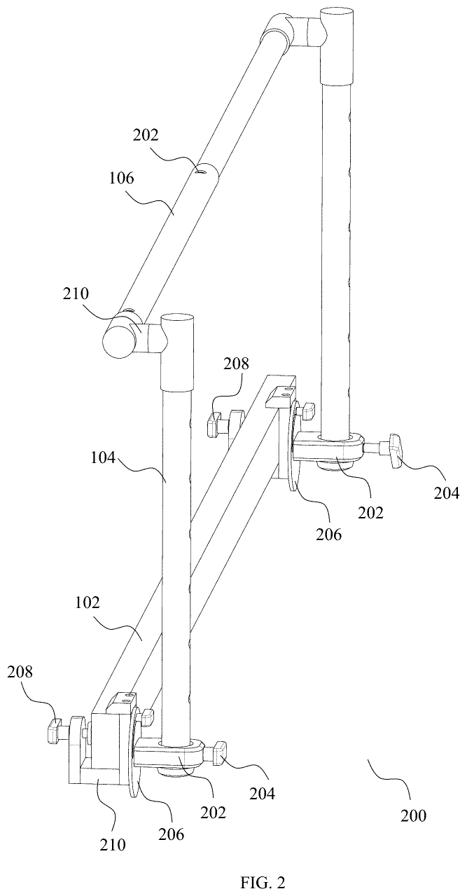

FIG. 2 presents an exploded perspective view 200 of the safety handrail system, disclosing its core components and subassemblies. The mounting assemblies 210 incorporate press mechanisms 210, each configured to grip the ladder stile 102 using opposed jaws actuated by a knob 208. The press mechanism 210 also includes a sleeve 202 that receives an upright support member 104. The sleeve 202 is provided with multiple holes into which a locking element 204, such as a pop-pin or manual pin, can be inserted to lock the vertical height of the upright support member 104. The sleeve 202 is fixed to a circular plate 206, which enables angular adjustment of the upright support member 104 relative to the ladder stile. The circular plate 206 rotates about an axis parallel to the ladder stile 102 and is lockable using a locking element 304 that passes through a sleeve 302 within the circular plate. The handrail member 106 includes a telescopic mechanism that permits horizontal length adjustment, ensuring that it remains engaged with both upright support members 104 regardless of their relative vertical positions.

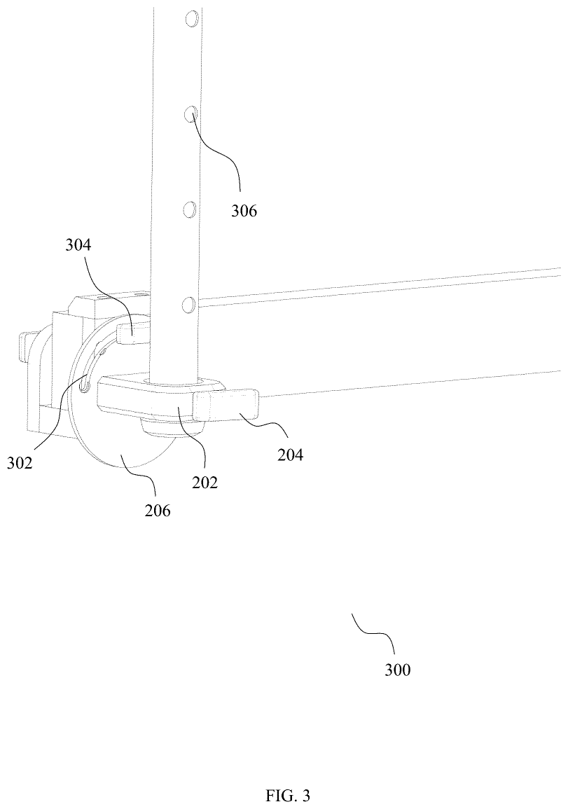

FIG. 3 shows a close-up view 300 of the mounting assembly and pivot mechanism connected to a ladder stile 102. The upright support member 104 extends through the sleeve 202 and is secured at the selected vertical height by insertion of the locking element 204 into one of the holes 306 in the upright support member. The circular plate 206, fixed to sleeve 202, facilitates angular adjustment of the upright support member 104 and is secured at the desired angle by the locking element 304. The knob 208 on the press mechanism 210 applies clamping force to secure the mounting assembly 210 to the ladder stile 102. The configuration of components 202, 206, 208, 204, and 304 in this figure demonstrates the integrated design of the press, height adjustment, and angle adjustment mechanisms within the mounting assembly 210.

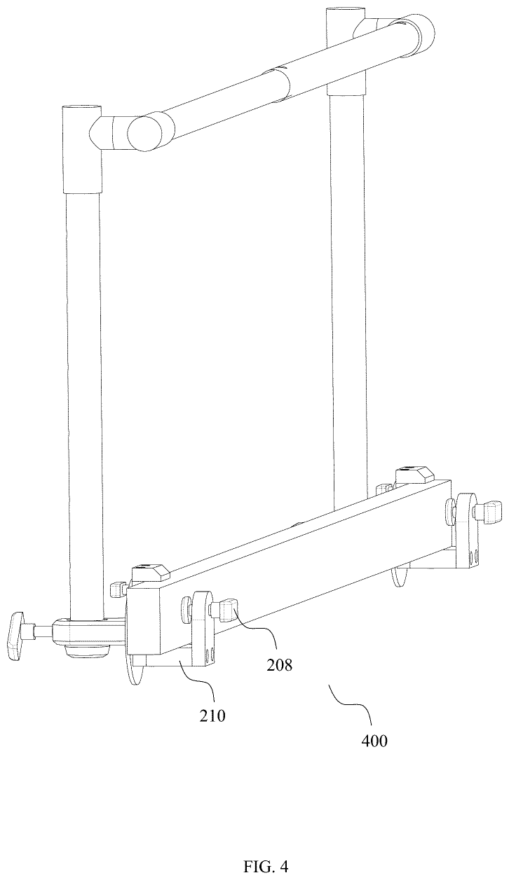

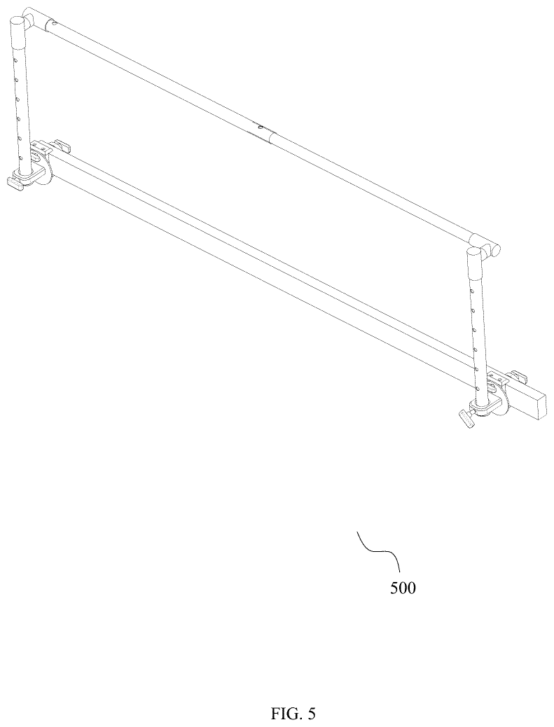

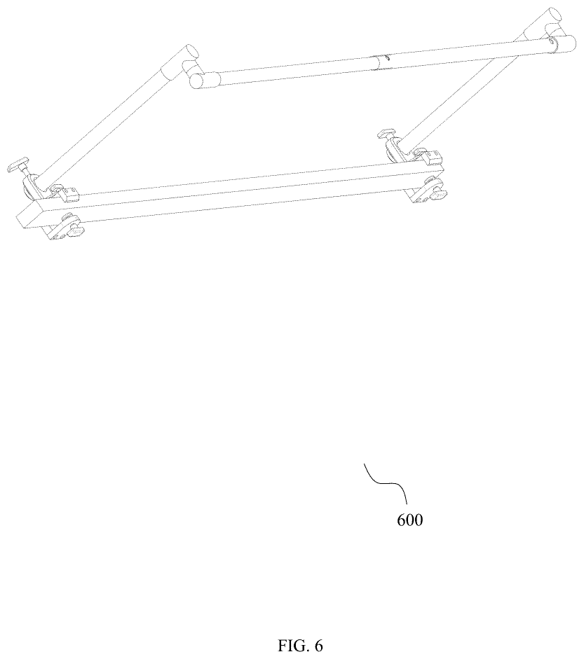

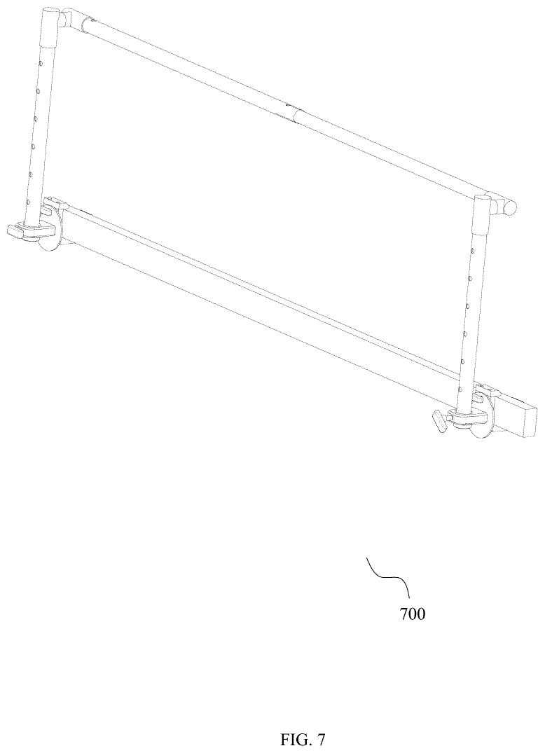

FIGS. 4 to 7 depict different perspective views 400, 500, 600, and 700 of the safety handrail system, highlighting its configurability and structural features. These views illustrate the engagement of the handrail member 106 with the upright support members 104 and show how the telescopic mechanism in the handrail member allows for adjustable horizontal length. The upright support members 104, clamped to ladder stiles 102 via mounting assemblies 210, are shown at varying vertical positions, with the locking elements 204 engaged in different holes 306 to demonstrate vertical adjustment capabilities. The angle adjustment achieved through rotation of the circular plates 206 and locking by locking elements 304 is also visible. The knob 208 of the press mechanism 210 ensures a secure, tool-free connection to the ladder stiles 102.

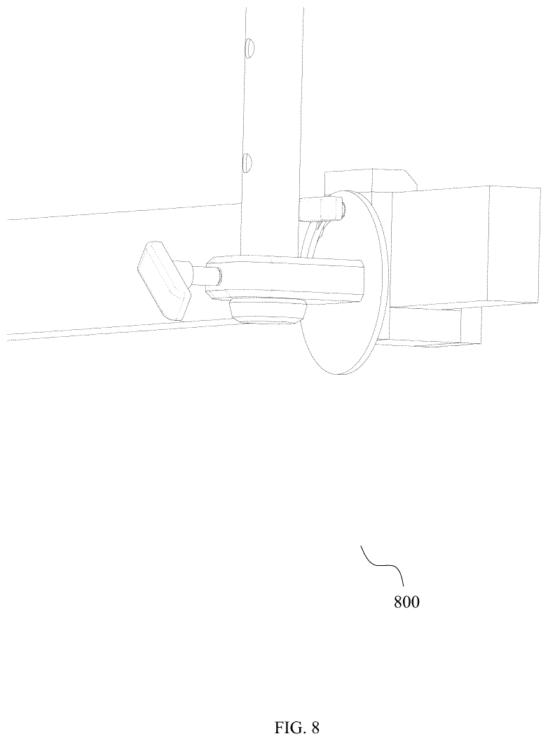

FIG. 8 provides a close-up view 800 of the mounting assembly, detailing the press mechanism 210 and its key components. The knob 208 actuates the opposed jaws of the press mechanism, applying clamping force to the ladder stile 102. The sleeve 202, integral to the mounting assembly 210, receives the upright support member 104 and provides holes for insertion of the locking element 204 to secure height adjustments. The circular plate 206 is fixed to the sleeve 202 and is shown in detail with its locking element 304 and sleeve 302 that facilitates controlled angle adjustment of the upright support member 104.

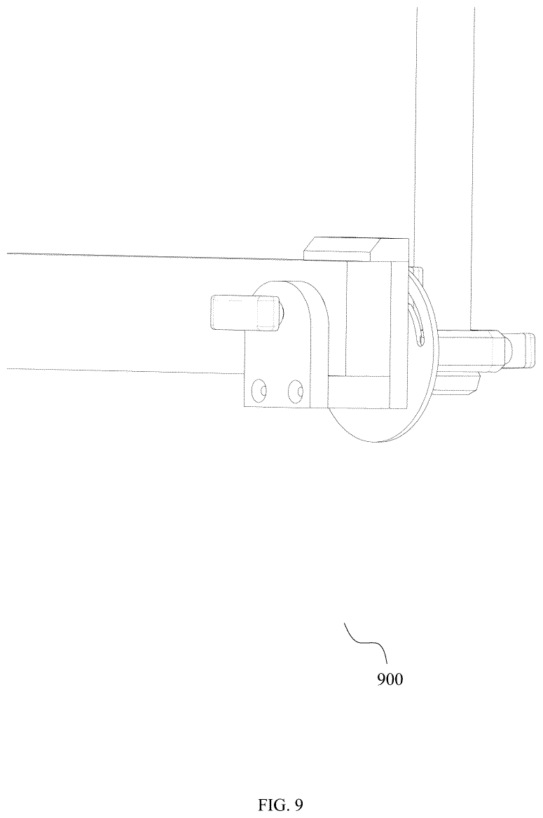

FIG. 9 is a rear-side close-up view 900 of the mounting assembly, providing an alternative perspective on the interaction of the key components. The upright support member 104 extends through the sleeve 202, with the locking element 204 securing the selected height via hole 306. The circular plate 206 rotates relative to the sleeve 202 and is locked at the chosen angle by locking element 304 passing through sleeve 302. The knob 208 of the press mechanism 210 is shown in position, applying pressure to clamp the mounting assembly 210 to the ladder stile 102.

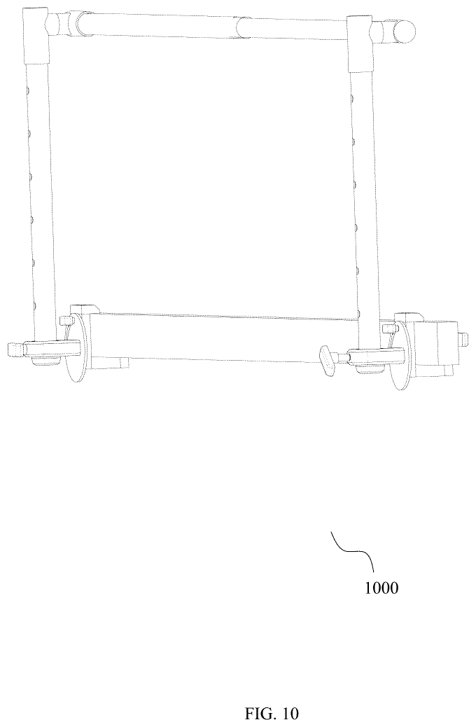

FIG. 10 presents a rear perspective view 1000 of the safety handrail system, showing its overall structure and arrangement of components when mounted to a ladder. The mounting assemblies 210, each incorporating the press mechanism 210, are secured to the ladder stiles 102, and the upright support members 104 extend upward from the mounting assemblies. The handrail member 106 bridges the two upright supports, and the telescopic mechanism is shown adjusted to accommodate differing heights of the upright supports. The rotation of the circular plates 206 and the engagement of the locking elements 304 and 204 are visible, demonstrating the adjustability of both angle and height. The configuration highlights the modularity and user-configurable nature of the system, which can be rapidly deployed or removed from the ladder without the use of tools.

The adaptable safety handrail system disclosed herein offers significant advantages over prior ladder safety solutions. A primary advantage lies in its universality and adaptability to a wide range of ladder designs and configurations. The mounting assemblies incorporate width-adjustable press mechanisms equipped with resilient friction-enhancing pads, enabling secure clamping to ladder stiles of varying profiles and dimensions. This universality eliminates the need for ladder-specific attachments and permits the system to be readily deployed across diverse job sites and tasks, thereby enhancing efficiency and reducing the logistical burden of carrying multiple accessories.

A further advantage is the comprehensive adjustability provided along three axes vertical, horizontal, and angular. The height adjustment mechanism, comprising a sleeve with multiple engagement holes and a locking element such as a pop-pin or manual pin, allows users to select the optimal vertical positioning of the upright support members to accommodate different user heights and work positions. The angle adjustment mechanism, implemented through a rotatable circular plate fixed to the sleeve and lockable via a friction-disc clamp or equivalent locking feature, provides precise control over the tilt angle of the upright support members relative to the ladder stiles. This enables the system to adapt to ladders positioned at varying inclinations and to user preferences, ensuring ergonomic handrail placement that minimizes strain and maximizes stability.

The handrail member itself offers a telescopic horizontal adjustment feature that compensates for differences in the vertical extension of the upright supports. This self-adjusting capacity ensures that the handrail remains securely engaged with both supports, maintaining continuous structural integrity and providing reliable upper-body support irrespective of ladder positioning or user configuration. The locking mechanism integrated into the handrail's telescopic feature secures the selected horizontal length, preventing accidental retraction or extension during use and further enhancing user safety.

Ease of use is another critical advantage of the disclosed system. The tool-free nature of the mounting assemblies, vertical and angular adjustments, and telescopic handrail extension significantly reduces setup and breakdown times. Users can install, adjust, and remove the system rapidly and efficiently without specialized tools or additional equipment. This feature is particularly valuable in commercial and industrial environments where time savings translate directly into increased productivity and reduced labor costs.

In terms of safety, the system offers a marked improvement over conventional ladder designs and aftermarket attachments. By providing a continuous, rigid handhold extending above the ladder, the system substantially reduces the risk of falls resulting from loss of balance, missteps, or ladder tipping. The combined use of height adjustment, angle adjustment, and horizontal telescopic mechanisms ensures that the handrail can be positioned precisely to meet the ergonomic needs of individual users, thereby improving stability, comfort, and confidence while working at height.

The modular construction of the system, employing durable materials such as aluminum or steel for structural components and elastomeric materials for contact surfaces, delivers a high strength-to-weight ratio and resilience against environmental conditions. The system's components are designed for longevity and repeated deployment without degradation of performance, making it a cost-effective investment for safety-conscious ladder users.

Additionally, the compactness and collapsibility of the system facilitate convenient storage and transport when not in use. The upright supports and handrail member can be retracted or folded into a compact form, and the mounting assemblies can be detached from the ladder without tools, allowing for easy portability between work locations. This feature supports rapid redeployment across multiple sites, accommodating the needs of tradespeople and contractors who frequently reposition ladders during their work.

Overall, the disclosed system effectively bridges the gap between basic ladder stabilizers, which provide limited support, and complex, ladder-specific safety platforms that require extensive setup and calibration. By integrating universal clamping, multi-axis adjustability, tool-free installation, and ergonomic support into a single, portable device, the invention delivers a comprehensive safety solution that addresses longstanding deficiencies in ladder safety equipment.

In various embodiments, the adaptable safety handrail system disclosed herein can be implemented with modifications or alternate configurations while retaining the essential functionality and advantages described. The core concept of a modular, telescopically adjustable, and angularly configurable handrail system adaptable to ladders remains applicable to numerous variations, including but not limited to the following alternate embodiments and extensions.

In certain embodiments, the press mechanism of the mounting assembly may be replaced or supplemented with alternative clamping configurations, such as cam-lock mechanisms, spring-biased clamping jaws, or magnetic clamps, provided these alternatives ensure secure attachment to ladder stiles while accommodating variations in stile dimensions and cross-sectional profiles. The friction-enhancing interface on the press mechanism may similarly be substituted with high-friction materials including textured elastomers, knurled metal surfaces, or advanced polymer composites with wear-resistant coatings. The width adjustment capability of the mounting assemblies may be configured with automatic adjustment features such as spring-loaded elements or ratchet mechanisms to accommodate stiles of varying sizes without manual reconfiguration.

The upright support members may, in alternate embodiments, incorporate telescopic extension mechanisms utilizing alternative locking elements including detent pins, quarter-turn locks, collet-based clamps, or automatic spring-loaded catch mechanisms. These variations allow rapid deployment or adjustment with minimal user effort while maintaining secure positioning. In some configurations, the telescopic elements may incorporate damped movement or soft-stop features to prevent abrupt extension or retraction that could destabilize the user.

The angle adjustment mechanism may be implemented using sector gears, toothed or serrated plates, or indexed discs with predefined detent positions instead of the continuous friction-disc clamp described. These alternate locking systems allow for precise, repeatable angle adjustments, which can be particularly advantageous in professional or regulated environments where angle consistency is mandated. In some embodiments, the circular plate may be configured with integrated measurement scales, visual indicators, or mechanical stops to facilitate rapid and repeatable positioning. The axis of rotation of the angle adjustment mechanism may be altered to accommodate different ladder geometries, including tilting in a plane orthogonal to the plane of the ladder stile or implementing a compound pivot mechanism to allow multi-axis angle adjustment.

The telescopic mechanisms of both the upright support members and the handrail member are configured to provide smooth extension and retraction with minimal play or backlash. To further enhance the sliding performance and reduce friction during adjustment, the sliding surfaces may be treated with various surface treatments. These treatments may include low-friction coatings such as polytetrafluoroethylene (PTFE, also known as Teflon), anodizing to create a hard and wear-resistant surface layer, electro-nickel plating for corrosion resistance and enhanced lubricity, ceramic coatings to provide a low-friction and durable surface, or polishing and electro-polishing to minimize surface irregularities. Such surface treatments not only reduce friction but also extend the operational life of the components by resisting wear, corrosion, and environmental degradation. These treatments may be applied to either or both the inner and outer surfaces of the telescopic elements, including the tubular segments of the handrail member and the telescoping upright supports. The choice of surface treatment may be adapted to specific use cases, environmental conditions, and user requirements, providing flexibility and ensuring consistent performance of the telescopic mechanisms under varying loads and usage scenarios.

The handrail member, in alternate embodiments, may be formed from non-circular cross-sectional profiles such as square, hexagonal, or oval tubing to enhance grip and torsional rigidity. The telescopic mechanism may employ nested channels with keyed alignment features to prevent rotation during extension or retraction. Locking mechanisms for the telescopic handrail may include automatic locking pins, quarter-turn cam locks, or integrated ratchet-and-pawl systems to enhance ease of use. Furthermore, the telescopic range of the handrail may be extended beyond the standard horizontal axis to include diagonal or curved configurations, permitting adaptation to ladders used in confined spaces or irregularly shaped work environments.

In certain embodiments, the system may be provided with supplemental components such as integrated tool trays, accessory hooks, or detachable safety harness anchor points to expand its utility beyond providing a handrail. The system may further incorporate sensors or indicators, such as electronic angle sensors, load sensors, or indicator LEDs, to provide real-time feedback on system alignment, locking status, or load conditions, thereby enhancing user safety and regulatory compliance.

The system may also be adapted for use with non-ladder structures, such as scaffolding, mobile platforms, or modular access systems, through replacement or adaptation of the mounting assemblies to interface with horizontal, vertical, or angled support elements. Mounting assemblies may be provided with modular interfaces, such as interchangeable jaws or adapters, to facilitate cross-platform compatibility.

Material selection for the components may be varied to suit specific use cases, including lightweight composites for aerospace or transport applications, corrosion-resistant alloys for marine or chemical environments, or dielectric materials for use near high-voltage equipment. Surface treatments such as anodizing, powder coating, or anti-corrosion plating may be applied to extend the operational life and environmental resilience of the system.

Embodiments may also be configured with integrated or detachable stabilizers extending from the mounting assemblies to engage the ladder rungs or adjacent structures, providing additional lateral support or enhancing load-bearing capacity. In some variants, the system may incorporate collapsible or foldable components, such as hinged handrail members or telescoping upright supports with automatic retraction mechanisms, to further streamline storage and transport.

Alternate embodiments may modify the relative proportions, geometries, or configurations of the system to accommodate specific ladder types, such as A-frame ladders, extension ladders, multi-position ladders, or platform ladders. The system may be configured for permanent or semi-permanent installation on certain ladder models through mechanical fasteners or adhesive bonding, provided that key functional elements including adjustability and modularity are retained.

It is further envisioned that future embodiments may incorporate smart technology features, such as wireless communication modules for integration with worksite safety management systems, user identification and tracking, or automated compliance logging. The system may include modular power sources, such as rechargeable batteries or energy-harvesting elements, to support these features without requiring external power connections.

These alternate embodiments and variations are illustrative and do not limit the scope of the present disclosure. It is expressly intended that all modifications, enhancements, and substitutions that are functionally equivalent to the elements described herein are considered within the scope of the claims. The described system architecture is inherently modular and may be adapted or augmented to suit evolving safety requirements, ladder technologies, and worksite practices.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. An adaptable safety handrail system configured for temporary attachment to a ladder, comprising:
(a) a pair of mounting assemblies configured to be removably secured to respective ladder stiles, each mounting assembly including:
(i) a press mechanism configured to secure the mounting assembly to the ladder stile with a friction-enhancing interface to inhibit slippage;
(ii) a height adjustment mechanism comprising a sleeve having a plurality of holes, the sleeve configured to receive an upright support member therethrough and to permit sliding of the upright support member to adjust its vertical position, the vertical position being locked by engagement of a locking element passing through one side of the sleeve into a selected hole of the upright support member; and
(iii) an angle adjustment mechanism comprising a rotatable circular plate fixed to the sleeve, the circular plate defining an axis of rotation substantially parallel to the ladder stile and including a locking feature to secure the selected angular orientation of the upright support member relative to the mounting assembly; and
(b) a handrail member extending between the upright support members, the handrail member including a telescopic mechanism configured to adjust the horizontal length of the handrail to accommodate variations in the vertical extension of the upright support members, and a locking mechanism to fix the selected length.

2. The system of claim 1, wherein the telescopic mechanism of the handrail member is configured to compensate for differences in the vertical positions of the upright support members, such that the handrail remains continuously connected to both upright support members at varying heights.

3. The system of claim 1, wherein the telescopic mechanism of the handrail member includes a locking element comprising a manual knob, lever, or pin configured to fix the handrail length after adjustment.

4. The system of claim 1, wherein the telescopic mechanism of the handrail member is linearly adjustable and includes an overlapping tubular segment that slides telescopically relative to an adjoining segment.

5. The system of claim 1, wherein each mounting assembly further comprises a pair of opposed jaws and a hand-operated threaded clamp configured to draw the jaws toward one another to grip the ladder stile.

6. The system of claim 5, wherein interior surfaces of the opposed jaws carry removable pads formed of a resilient, friction-enhancing material.

7. The system of claim 5, wherein each mounting assembly includes a width-adjustment guide that permits the opposed jaws to accommodate ladder stiles of different thicknesses.

8. The system of claim 1, wherein the locking element is a spring-loaded pop-pin configured to releasably engage one of the plurality of holes in the sleeve and the corresponding upright support member.

9. The system of claim 1, wherein the locking feature of the circular plate comprises a friction-disc clamp tightened by a hand knob to lock the angular orientation of the upright support member.

10. A method of using an adaptable safety handrail system configured for temporary attachment to a ladder, the method comprising:
attaching a pair of mounting assemblies to opposing ladder stiles by engaging press mechanisms to secure each mounting assembly to a corresponding stile;
adjusting the vertical position of an upright support member by sliding it through a sleeve having a plurality of holes and locking the upright support member at a selected height using a locking element that engages one of the holes;
adjusting the angular orientation of the upright support member relative to the mounting assembly by rotating a circular plate fixed to the sleeve and locking the selected angle;
adjusting the length of a handrail member extending between the upright support members to compensate for differences in their vertical positions; and
locking the handrail member at the selected length.

11. The method of claim 10, wherein the step of locking the handrail member at a selected horizontal length comprises engaging a manual locking element such as a knob, lever, or pin.

12. The method of claim 10, wherein the step of locking the upright support member at a selected height comprises inserting a spring-loaded pop-pin through one of the plurality of holes in the sleeve and into a corresponding hole of the upright support member.

13. The method of claim 10, wherein the step of locking the angular orientation of the upright support member comprises tightening a friction-disc clamp with a hand knob.

14. The method of claim 10, further comprising manually disengaging the press mechanisms of the mounting assemblies to remove the safety handrail system from the ladder without tools.

15. The method of claim 10, further comprising collapsing the telescopic mechanism of the handrail member and releasing the angle adjustment mechanism to fold the safety handrail system into a compact configuration for storage or transport.
